(19) United States
(12) Patent Application Publication
(10) Pub. No.: US 2009/0180181 A1
(43) Pub. Date: Jul. 16, 2009

(54) Projector with Three Dimensional Simulation and Extended Dynamic Range

(76) Inventor: William S. Oakley, San Jose, CA (US)

Correspondence Address: TIPS GROUP;c/o Intellevate LLC, P. O. BOX 52050, Minneapolis, MN, 55402, US

(21) Appl. No.: 12/015,502

(22) Filed: Jan. 16, 2008

(51) Int. Cl. G02B 27/28

(52) U.S. Cl. 359/485

(57) ABSTRACT

In an embodiment, an apparatus is provided. The apparatus includes a first polarizing beam splitter to receive light from an input source and provide a first output with a first polarization and a second output with a second polarization. The apparatus further includes a half-wave plate arranged to receive the first output of the first polarizing beam splitter and provide a half-wave plate output having the second polarization. The apparatus also includes a mirror arranged to receive the second output beam of the first polarizing beam splitter and provide a mirror output having the second polarization. The apparatus may further include a second polarizing beam splitter to receive the half-wave plate output and the mirror output and transmit the half-wave plate output and the mirror output to an external reflective component. The second polarizing beam splitter is further to receive reflected light from the reflective component and to transmit the light from the reflective component as an external output beam. The apparatus may use a reflective component which is an image modulation component.

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a Consortium of studios has set forth a standard for future digital projection systems. While this standard is by no means final, it provides a rough guide as to what a system must do—what specifications must be met. Thus, it may be useful to provide a digital projection system which meets the standards of the studio Consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a display system.

FIG. 2 illustrates an embodiment of a process of cycling colors and polarization states.

FIG. 3A illustrates an alternate embodiment of a display system.

FIG. 3B further illustrates an embodiment of a complex polarization beam splitter of FIG. 3A.

FIG. 4 illustrates another alternate embodiment of a display system.

FIG. 5 illustrates an embodiment of a process of projecting an image.

FIG. 6 illustrates an alternate embodiment of a process of projecting an image.

FIG. 7 illustrates an embodiment of a system using a computer and a projector.

FIG. 8 illustrates an embodiment of a computer which may be used with the projectors of FIGS. 1, 3 and 4, for example.

FIG. 9 illustrates yet another embodiment of a system using a computer and a projector.

### DETAILED DESCRIPTION

A system, method and apparatus is provided for a projector with three dimensional simulation and extended dynamic range. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

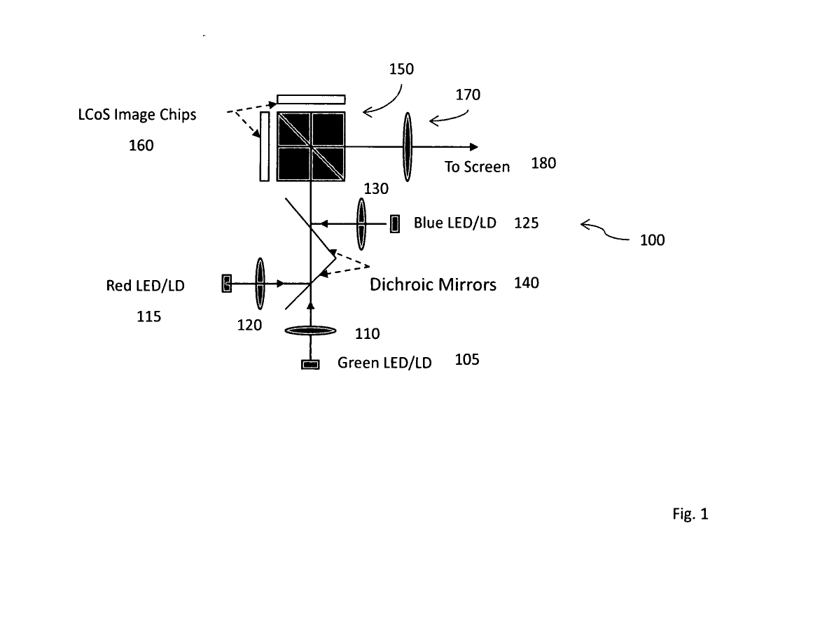

A moderate sized (e.g. 2×3 m) image of modest brightness can be projected onto a surface by three Light Emitting Diodes (LEDs), or Laser Diodes (LDs), each of a different color, e.g. red, green, blue, or yellow, cyan, magenta, repetitively pulsed in rapid sequence so as to simultaneously illuminate two LCoS image generation chips with the same color light pulse, but with complimentary optical polarization as determined by the light pulse passing through a broadband polarizing beam splitter cube as shown in FIG. 1. Each LED/LD beam exits the cube after reflection from an LCoS image chip having been polarization modulated on a pixel by pixel basis by a digital image electronically written to the LCoS chip. The two oppositely linear polarized, three color, image beams returning through the polarizing beam splitter combine to produce a 3-color image, video or static. When viewed through polarizing glasses and with appropriate images input to the two LCoS chips, the images can produce a simulated 3D image.

Turning to the specific components of FIG. 1, a projection system 100 is displayed. Light sources 105, 115 and 125 each provide one of green, red and blue light, respectively. Each light source is tuned through optics 110, 120, and 130, which may be used to focus the light or otherwise transform the light output of lights sources 105, 115 and 125, respectively. Dichroic mirrors 140 are used to combine the multiple sources of light into a single light source entering polarizing beam splitter 150.

Polarizing beam splitter 150 splits the light into two orthogonally polarized light beams, with each polarized light beam bouncing off of an LCoS image chip 160. LCoS image chips 160 modulate the light based on data supplied from an outside source, to create two images (one for each polarized beam). Polarizing beam splitter 150 combines the beams coming from LCoS image chips 160, providing an output beam that passes through output optics 170 and creates an output beam 180 which may be projected on a screen.

Another option for producing a 3D image simulation is to pass the output images through a single Liquid Crystal phase plate which converts the two linearly polarized output beams of each color sequence into opposed circularly polarized beams, eliminating image degradation by rotation of the viewer's head as occurs with linearly polarized 3D viewing systems. The wave plate voltage may be optimized for each color in turn and sequenced in synchronization with the illuminating LEDs/LDs.

The optical projection system shown in FIG. 1 provides a relatively limited size image due to the moderately low power of presently available LEDs. The three output beams, e.g. red, green, and blue, are combined with dichroic mirrors when LEDs are employed as light sources but if LDs are used each source can be coupled to an output fiber optic and the three fibers bundled so their outputs are in close proximity, eliminating the need for separate beam collimating lenses and beam combining dichroic mirrors. Advances in LED power potentially will eliminate or reduce restrictions on the size of the image or corresponding power of the beam.

When a dark scene is projected the image dynamic range of the projected display may be extended by reducing the output power of the light sources and simultaneously increasing the image chip transmission to precisely compensate for the reduced LED/LD outputs. For digitally generated masters, the scene brightness can be coded directly to the three light sources if desired, eliminating the need to pre-scan the image and build a file of source intensity values synchronized with image chip modulation states.

The LEDs/LDs can also be replaced by a white light source and a rotating colored filter wheel with each color filter appropriately synchronized with the image chip signals. Moreover, the three color display can be extended to include the use of near infra red images if desired for simulation and training purposes. This would involve extending the light sequence to four or more pulses with a corresponding increase in the pulse repetition rate for any given frame rate. Combining a fourth light source (or fourth filter for a white light source) can be accomplished based on the design shown in FIG. 1, for example.

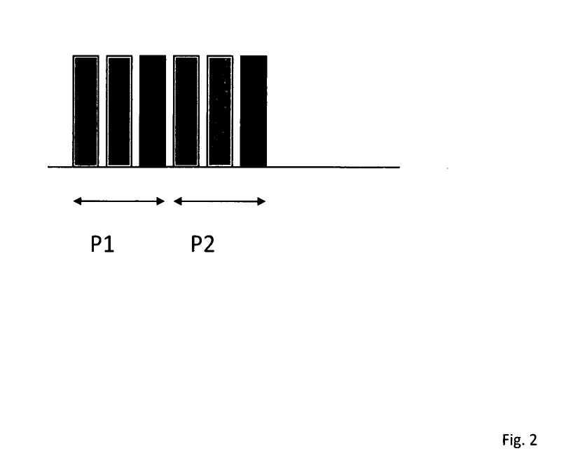

An alternative is the use of a single image chip illuminated with laser diodes whose outputs, unlike LEDs, are optically polarized. This allows both images of a 3D display to be generated from the same image chip with full optical efficiency but requires the color sequence be cycled at twice the rate, 144 Hertz for a 24 frames per second display, and an electrically driven wave plate be positioned at the output to switch the polarization state prior to each color sequence, i.e. at a 48 Hertz rate. In this configuration the optics is the same as in FIG. 1 but with only one image generation LCoS chip. Full optical efficiency is obtained without a faster color sequence cycle rate or a wave plate if 3D effects are not required. The two polarizations, P1, P2, three color RGB sequence for 3D images is shown in FIG. 2. The different colors can be pulsed and the polarizations controlled to allow for the repeating sequence, and synchronization with data provided to the LCoS chip results in the desired projected images.

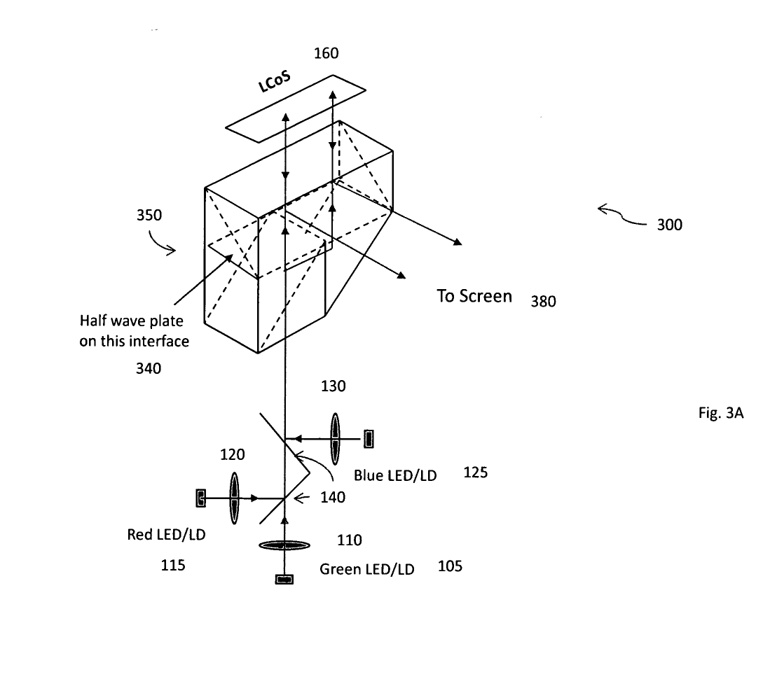

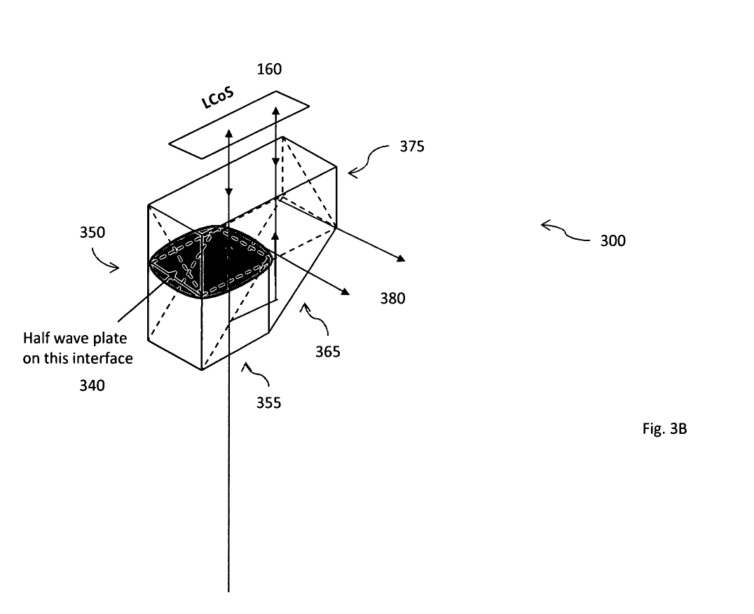

A similar display system using sequentially pulsed LEDs can be configured using a single image generation chip (LCoS) with maximum light efficiency if both polarizations from the light sources can be directed to the same image chip. This can be accomplished by means of a polarization combining prism which separates an input beam into two polarizations, and rotates one to be oriented similarly to the other. The two halves of the input beam illuminate the two halves of an image generating chip as shown in FIG. 3A. A single polarization beam splitter would suffice if half the light from the LEDs were not used.

Using a light source similar to that of FIG. 1, one can interpose a more complex polarization beam splitter between the light source and an LCoS chip 160 in display system 300, resulting in creation of two output beams with the same polarization. Beam splitter 350 splits a beam into two beams with the same polarization state. By including a half-wave plate 340 at an interface within the beam splitter 350, one of the beams (the beam passing through the half-wave plate) is polarization rotated to the same state as the other (the beam passing through the mirror and around the half-wave plate) so each beam illuminates a different half of the LCoS chip with the same polarization. Note that the half-wave plate 340 extends only through half of the interface with beam splitter 350—thus it only interacts with one of the beams and has no effect on the other beam. The result is two beams directed at the LCoS chip 160 with the same polarization. The resulting output beams 380 are then directed at a screen, potentially through further projection optics. Note that LCoS chip 160 may need to have twice the width of the LCoS chips 160 of FIG. 1, to accommodate the two beams from beam splitter 350. Alternatively, a lower resolution image can be produced using half of one LCoS chip 160 for each beam.

FIG. 3B further illustrates the complex polarization beam splitter 350. Prism 355 receives light from a light source, and splits it into two light beams having orthogonal polarization states. Mirror 365 reflects one beam with a first polarization state upward (in this perspective). Half wave plate 340 rotates the polarization state of the other beam from a second polarization state to the first polarization state. As a result, two beams are transmitted through prism 375 to a reflective optical component, such as LCoS 160, with each having the same polarization state. Note that whether the first or second polarization state is chosen is not material. The reflective component then reflects light back (potentially modulated for an image) through prism 375, which reflects the light from the reflective optical component 160 as output light 380.

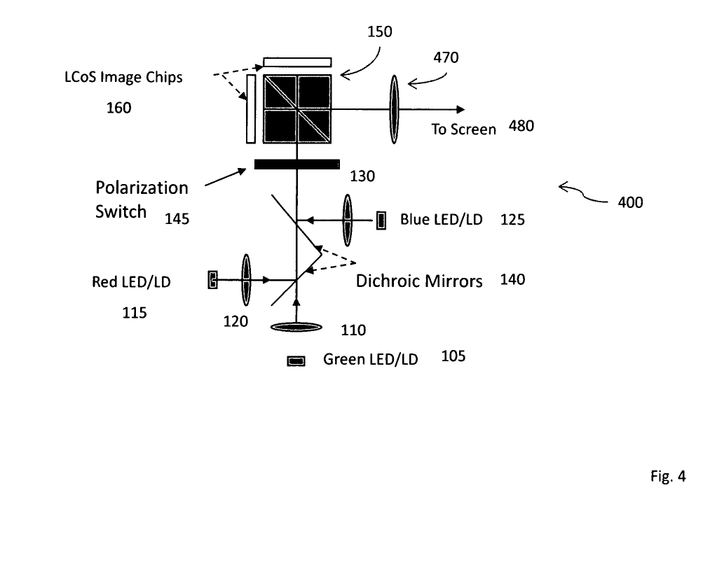

The eye sensitivity to frame rates flicker increases with display brightness, requiring faster frame rates for comfortable viewing. The display frame rate is limited by the time to refresh the LCoS imaging chip and the duration of the light pulse for the refreshed image. One means of maximizing the frame rate is to alternately refresh the two polarization states and illuminate the chip not being refreshed, i.e. one chip is being refreshed while the other is being illuminated. This is accomplished by a slightly modified laser diode illumination system where a polarization switch (e.g. a liquid crystal wave plate), is used to alternate the light pulses between two image chips as in FIG. 4. This also allows the laser diode illumination of each image chip for 50% of the time, or 16.66% for each of three colors. The same technique can be used with LEDs if the input (LED output) to the switch is first polarized.

In the circumstance where the image is projected onto a screen which does not preserve the polarization of the projected light the viewer will not perceive a 3D effect even with polarized glasses. If the 3D images are projected sequentially the 3D effect will be perceived if viewed through active light blocking glasses, operating synchronously with projection of the image. The two sets of images which provide 3D information are seen by the viewer with the glasses alternately blocking and passing the appropriate image sequence to each eye. In such an embodiment, this requires the projected images and the transmission of the glasses be synchronized so the appropriate image is seen. The alternate sides of the glasses are blocked/opened so a different image sequence passes through each side of the viewers glasses. The synchronization of the projected image and the viewer's glasses is achieved by a signal transmitted by the projector and received by the viewer's glasses. One option for achieving this is by a very low power radio frequency signal.

Turning to FIG. 4, system 400 uses polarization switch 145 to produce two differently polarized states of light entering beam splitter 150. The resulting output light is transmitted through projection optics 470 to provide output beam 480, which may be projected on a screen. Polarization switch 145, as mentioned with regard to FIG. 2, can be used to impart circular polarization, such as clockwise and anti-clockwise polarization, for example.

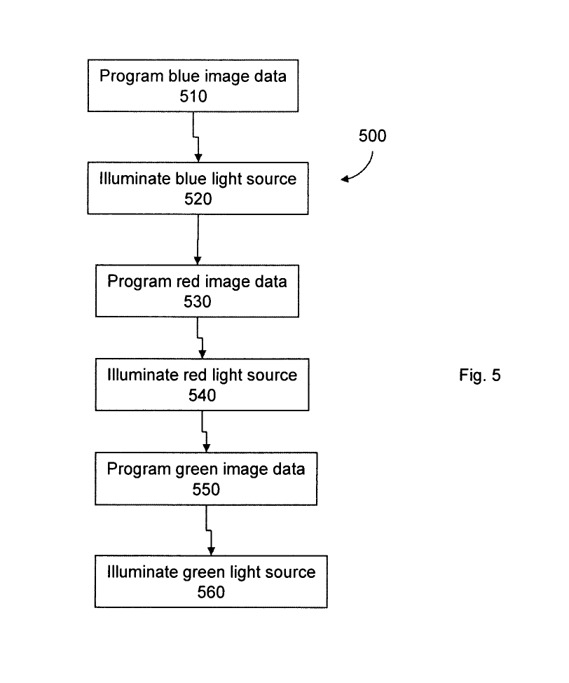

The process of some of these embodiments can be further illustrated with reference to FIG. 5. Process 500 includes programming data for blue light, illuminating blue light, programming data for red light, illuminating red light, programming data for green light and illuminating green light. This round robin process can be repeated for each frame resulting in the projection of an image through the embodiment of FIG. 1, for example. Process 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

Process 500 initiates with programming of an LCoS chip with data for display of a blue image at module 510. At module 520, a blue light source is illuminated (or a color wheel is turned to blue). This, through use of appropriate optics, results in display of the blue image as modulated by the LCoS chip. At module 530, the LCoS chip is programmed for display of a red image. Likewise, at module 540, a red light source is illuminated (or a color wheel is turned to red), and the corresponding red image as modulated by the LCoS chip is displayed. At module 550, the LCoS chip is programmed for display of a green image. Likewise, at module 560, a green light source is illuminated (or a color wheel is turned to green), and the corresponding green image as modulated by the LCoS chip is displayed. This process can then be repeated for each frame (or multiple times for each frame) as needed. Moreover, the process can be expanded for other colors or light sources (e.g. infrared) or changed for a different set of colors (e.g. cyan, magenta, yellow).

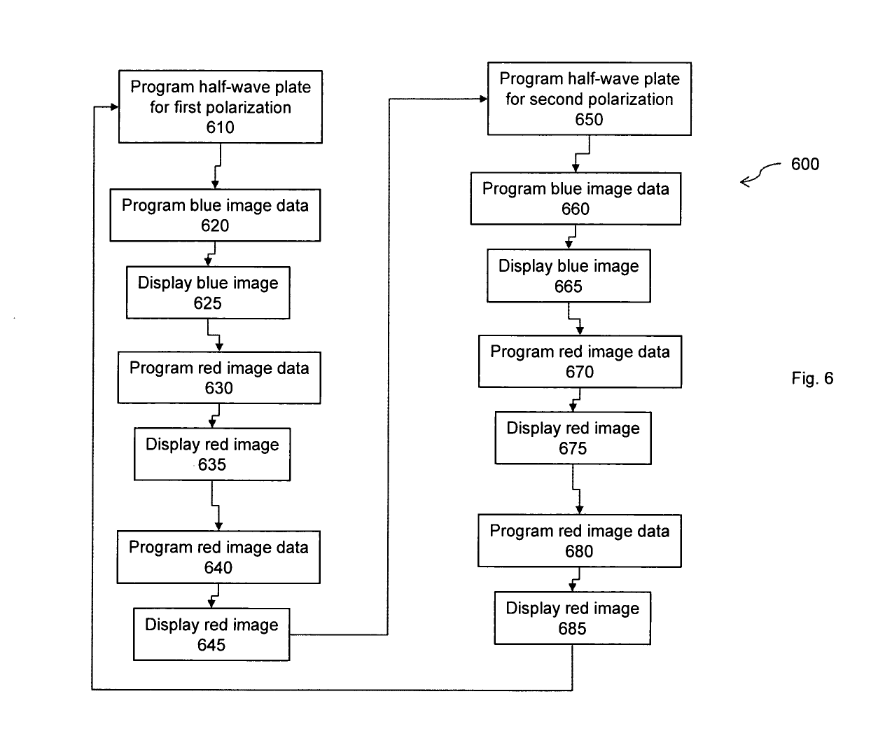

Process 600 of FIG. 6 illustrates an alternative process for display of an image. Process 600 includes programming a half-wave plate for a first orientation, programming data and illuminating a light source for each of blue, red and green light, programming the half-wave plate for a second orientation, and then programming data and illuminating a light source for each of blue, red and green light. Thus, process 600 allows for display of two different polarizations of each of three different light sources (or three types of light). The first and second orientations may be two different (potentially orthogonal) linear polarizations, or two different time-varying polarizations (e.g. circular), for example.

Process 600 initiates with programming of a half-wave plate for a first polarization at module 610. Thus may involve a time-varying polarization or a constant polarization, and thus may involve production of a biasing voltage. At module 620, an LCoS chip is programmed with data for display of a blue image. At module 625, a blue light source is illuminated (or a color wheel is turned to blue). Through use of appropriate optics, the blue image as modulated by the LCoS chip is displayed. At module 630, the LCoS chip is programmed for display of a red image. At module 635, a red light source is illuminated (or a color wheel is turned to red), and the corresponding red image as modulated by the LCoS chip is displayed. At module 640, the LCoS chip is programmed for display of a green image. Likewise, at module 645, a green light source is illuminated (or a color wheel is turned to green), and the corresponding green image as modulated by the LCoS chip is displayed.

Process 600 continues with programming of a half-wave plate for a second polarization at module 650. The process then proceeds to programming an LCoS chip with data for display of a blue image at module 660. At module 665, a blue light source is illuminated (or a color wheel is turned to blue), and the blue image as modulated is displated. The LCoS chip is programmed for display of a red image at module 670. At module 675, a red light source is illuminated (or a color wheel is turned to red), and the corresponding red image as modulated by the LCoS chip is displayed. At module 680, the LCoS chip is programmed for display of a green image. Likewise, at module 685, a green light source is illuminated (or a color wheel is turned to green), and the corresponding green image as modulated by the LCoS chip is displayed. This process can then be repeated for each frame (or multiple times for each frame) as needed, and can be expanded or changed for other light sources.

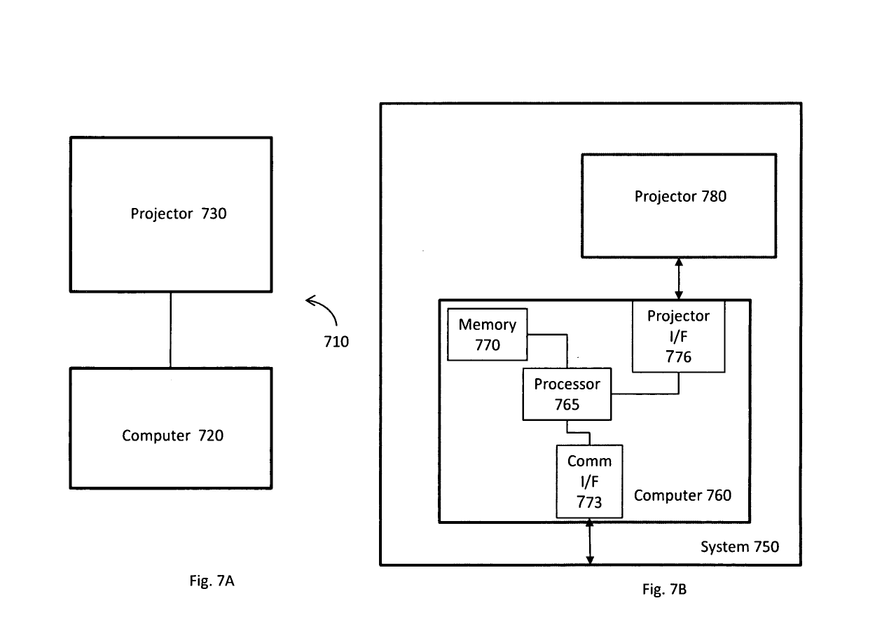

FIG. 7A illustrates an embodiment of a system using a computer and a projector. System 710 includes a conventional computer 720 coupled to a digital projector 730. Thus, computer 720 can control projector 730, providing essentially instantaneous image data from memory in computer 720 to projector 730. Projector 730 can use the provided image data to determine which pixels of included LCoS display chips are used to project an image. Additionally, computer 720 may monitor conditions of projector 730, and may initiate active control to shut down an overheating component or to initiate startup commands for projector 730.

FIG. 7B illustrates another embodiment of a system using a computer and projector. System 750 includes computer subsystem 760 and optical subsystem 780 as an integrated system. Computer 760 is essentially a conventional computer with a processor 765, memory 770, an external communications interface 773 and a projector communications interface 776.

The external communications interface 773 may use a proprietary (a standard developed for such a device but not publicized by its developer), or a publicly available communications standard, and may be used to receive both digital image data and commands from a user. The projector communications interface 776 provides for communication with projector subsystem 780, allowing for control of LCoS chips (not shown) included in projector subsystem 780, for example. Thus, projector communications interface 776 may be implemented with cables coupled to LCoS chips, or with other communications technology (e.g. wires or traces on a printed circuit board) coupled to included LCoS chips. Other components of computer subsystem 760, such as dedicated user input and output modules, may be included, depending on the needs for functionality of a conventional computer system in system 750. System 750 may be used as an integrated, standalone system—thus allowing for the possibility that each theater may use its own projector with a built-in control system, for example.

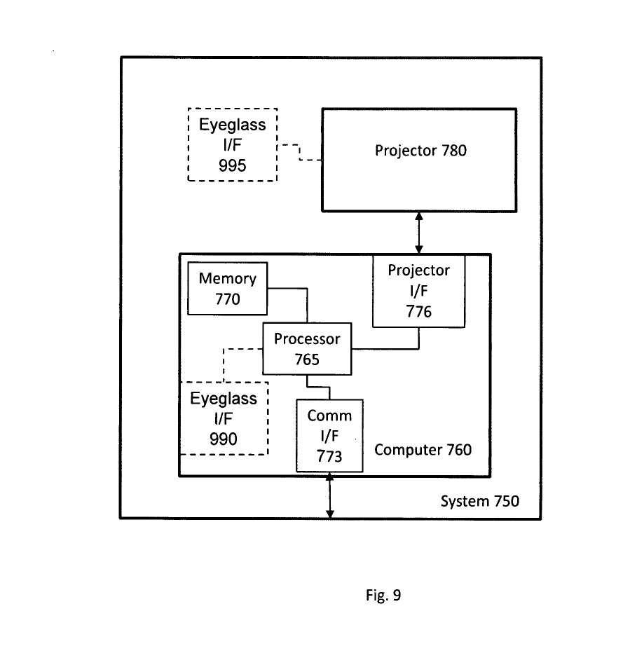

FIG. 9 illustrates yet another embodiment of a computer and projector system. Added to the embodiment of FIG. 7B are two optional eyeglass interface components. Eyeglass interface 990 allows for control of eyeglasses through use of a processor 765 controlling the projector 780. Alternatively, eyeglass interface 995 allows for direct communication between the projector 780 and eyeglass interface 995—thereby allowing for a standalone design, for example. Each of eyeglass interface 990 and 995 may be expected to send out signals to control polarized glasses such as those discussed above.

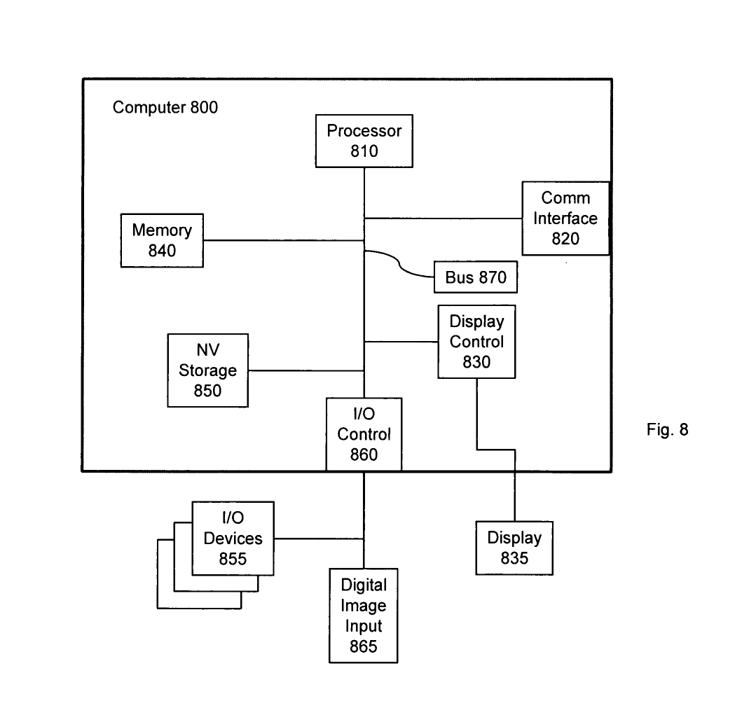

FIG. 8 illustrates an embodiment of a computer which may be used with the projectors of FIGS. 1, 3 and 4, for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an i/o controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows(r) from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Further consideration of various embodiments may provide additional insights. In one embodiment, an apparatus is provided. The apparatus includes a first polarizing beam splitter to receive light from an input source and provide a first output with a first polarization and a second output with a second polarization. The apparatus further includes a half-wave plate arranged to receive the first output of the first polarizing beam splitter and provide a half-wave plate output having the second polarization. The apparatus also includes a mirror arranged to receive the second output beam of the first polarizing beam splitter and provide a mirror output having the second polarization. The apparatus may further include a second polarizing beam splitter to receive the half-wave plate output and the mirror output and transmit the half-wave plate output and the mirror output to an external reflective component. The second polarizing beam splitter is further to receive reflected light from the reflective component and to transmit the light from the reflective component as an external output beam. The apparatus may use a reflective component which is an image modulation component.

In another embodiment, a system is provided. The system includes a housing. The system further includes a first light source coupled to the housing, the first light source providing red light. The system also includes a second light source coupled to the housing, the second light source providing green light. The system further includes a third light source coupled to the housing, the third light source providing blue light. The system also includes a first beam combining optical element and a second beam combining optical element both coupled to the housing. The first beam combining optical element is arranged to receive light from the first light source and the second light source. The second beam combining optical element is arranged to receive light from the first beam combining optical element and from the third light source.

The system further includes an LCoS assembly coupled to the housing and arranged to receive light from the second beam recombining element. The LCoS assembly includes a polarization beam splitter arranged to receive light from the second beam combining element. The polarization beam splitter includes a first polarizing beam splitter to receive light from the second beam combining element and provide a first output with a first polarization and a second output with a second polarization. The polarization beam splitter further includes a half-wave plate arranged to receive the first output of the first polarizing beam splitter and provide a half-wave plate output having the second polarization. The polarization beam splitter further includes a mirror arranged to receive the second output beam of the first polarizing beam splitter and provide a mirror output having the second polarization. The polarization beam splitter also includes a second polarizing beam splitter to receive the half-wave plate output and the mirror output and transmit the half-wave plate output and the mirror output to an external reflective component. The second polarizing beam splitter receives reflected light from the reflective component and transmits the light from the reflective component as an external output beam.

The LCoS assembly further includes a first LCoS chip coupled to receive light from the polarization beam splitter and to reflect modulated light to the polarization beam splitter. The LCoS assembly also includes a second LCoS chip coupled to receive light from the polarization beam splitter and to reflect modulated light to the polarization beam splitter. The LCoS assembly may alternatively include a single LCoS chip coupled to receive light from the polarization beam splitter of both the half-wave plate output and the mirror output and to reflect modulated light to the polarization beam splitter.

The system may further include a first focusing optical element interposed between the first light source and the first beam recombining optical element to focus light from the first light source on the first beam recombining element. The system may also include a second focusing optical element interposed between the second light source and the first beam recombining optical element to focus light from the second light source on the first beam recombining element. The system may further include a third focusing optical element interposed between the third light source and the second beam recombining optical element to focus light from the third light source on the second beam recombining element. The system may also include output focusing optics coupled to the housing and arranged to focus an output beam of the polarization beam splitter of the LCoS array. In some embodiments, the first beam recombining optical element is a dichroic mirror; and the second beam recombining optical element is a dichroic mirror.

The system may further include a controller coupled to the first light source, the second light source and the third light source. The controller may also be coupled to control light output of the first light source, the second light source and the third light source. The system may also include a polarization switch coupled to the controller and disposed between the second beam recombining optical element and the LCoS assembly. The polarization switch may be controlled by the controller. The system may also include an eyeglass interface coupled to the controller, the controller to determine signals output by the eyeglass interface. In some embodiments, the first light source is an LED, the second light source is an LED and the third light source is an LED. In other embodiments, the first light source is a laser diode, the second light source is a laser diode and the third light source is a laser diode. Furthermore, in some embodiments, the polarization switch is a PLZT switch.

The system may include a processor and a memory coupled to the processor. The system may also include a bus coupled to the memory and the processor. The system may further include a communications path between the processor and each of the first and second LCoS chips. The system may also include an interface coupled to the processor, the interface to receive data from a source external to the system. In some embodiments, the processor provides the controller.

In another embodiment, a system is presented. The system includes a housing. The system also includes a first light source coupled to the housing, the first light source providing red light. The system further includes a second light source coupled to the housing, the second light source providing green light. The system also includes a third light source coupled to the housing, the third light source providing blue light. Moreover, the system includes a first beam combining optical element and a second beam combining optical element both coupled to the housing. The first beam combining optical element is arranged to receive light from the first light source and the second light source. The second beam combining optical element is arranged to receive light from the first beam combining optical element and from the third light source. The system further includes an LCoS assembly coupled to the housing and arranged to receive light from the second beam recombining element.

In some embodiments, the LCoS assembly includes a polarization beam splitter arranged to receive light from the second beam combining element. The LCoS assembly further includes a first LCoS chip coupled to receive light of a first polarization from the polarization beam splitter and to reflect modulated light to the polarization beam splitter. The LCoS assembly also includes a second LCoS chip coupled to receive light of a second polarization from the polarization beam splitter and to reflect modulated light to the polarization beam splitter.

In some embodiments, the system further includes a first focusing optical element interposed between the first light source and the first beam recombining optical element to focus light from the first light source on the first beam recombining element. The system may further include a second focusing optical element interposed between the second light source and the first beam recombining optical element to focus light from the second light source on the first beam recombining element. The system may also further include a third focusing optical element interposed between the third light source and the second beam recombining optical element to focus light from the third light source on the second beam recombining element.

In some embodiments, the first beam recombining optical element is a dichroic mirror and the second beam recombining optical element is a dichroic mirror. In some embodiments, the system may further include output focusing optics coupled to the housing and arranged to focus an output beam of the polarization beam splitter of the LCoS array. Additionally, in some embodiments, the system further includes a controller coupled to the first light source, the second light source and the third light source. The controller is coupled to control light output of the first light source, the second light source and the third light source. Moreover, in some embodiments, the controller is to sequence the first light source, the second light source and the third light source.

The system may further include a polarization switch coupled to the controller and disposed between the second beam recombining optical element and the LCoS assembly, the polarization switch controlled by the controller. The system may also include an eyeglass interface coupled to the controller. The controller is to determine signals output by the eyeglass interface. The system may use a first light source, a second light source and a third light source that are LEDs. Alternatively, the system may use a first light source, a second light source and a third light source that are laser diodes. In some embodiments, the polarization switch is a PLZT switch.

Some embodiments of such systems may further include a processor and a memory coupled to the processor. Such embodiments may also include a bus coupled to the memory and the processor. Likewise, such embodiments may also include a communications path between the processor and each of the first and second LCoS chips. Additionally, such embodiments may include an interface coupled to the processor, the interface to receive data from a source external to the system.

In another embodiment, a method is provided. The method includes programming a light modulator with a blue image. The method also includes Illuminating a blue light source. The method further includes programming a light modulator with a red image. The method also includes illuminating a red light source. The method further includes programming a light modulator with a green image. The method also includes illuminating a green light source.

The method may also include programming a half-wave plate to pass light of a first polarization. The method may further include performing the programming of the blue, red and green images and the illuminating of the blue, red and green light sources. The method may likewise include programming a half-wave plate to pass light of a second polarization. The method may further include performing the programming of the blue, red and green images and the illuminating of the blue, red and green light sources. Additionally, the method may include focusing light output from the image modulator as an output beam. Moreover, the method may include controlling sequencing of the illuminating of the red, blue and green light sources.

In yet another embodiment, a system is provided. The system includes a housing. The system also includes a first light source coupled to the housing, the first light source providing red light. The system further includes a second light source coupled to the housing, the second light source providing green light. The system also includes a third light source coupled to the housing, the third light source providing blue light. The system also includes a first dichroic mirror and a second dichroic mirror both coupled to the housing. The first dichroic mirror is arranged to receive light from the first light source and the second light source, and the second dichroic mirror is arranged to receive light from the first dichroic mirror and from the third light source.

The system further includes a first focusing optical element interposed between the first light source and the first dichroic mirror to focus light from the first light source on the first beam combining element. The system also includes a second focusing optical element interposed between the second light source and the first dichroic mirror to focus light from the second light source on the first beam combining element. The system further includes a third focusing optical element interposed between the third light source and the second dichroic mirror to focus light from the third light source on the second beam combining element.

The system also includes a polarization beam splitter arranged to receive light from the second beam combining element. The system further includes a first LCoS chip coupled to receive light of a first polarization from the polarization beam splitter and to reflect modulated light to the polarization beam splitter. The system also includes a second LCoS chip coupled to receive light of a second polarization from the polarization beam splitter and to reflect modulated light to the polarization beam splitter. The system further includes Output focusing optics coupled to the housing and arranged to focus an output beam of the polarization beam splitter of the LCoS array.

The system also includes a controller coupled to the first light source, the second light source and the third light source. The controller is coupled to control light output of the first light source, the second light source and the third light source. The controller is to sequence the first light source, the second light source and the third light source. The system further includes a processor and a memory coupled to the processor. The system also includes a bus coupled to the memory and the processor. The system further includes a communications path between the processor and each of the first and second LCoS chips and the controller.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. An apparatus, comprising:
A first polarizing beam splitter to receive light from an input source and provide a first output with a first polarization and a second output with a second polarization;
A half-wave plate arranged to receive the first output of the first polarizing beam splitter and provide a half-wave plate output having the second polarization;
And
A mirror arranged to receive the second output beam of the first polarizing beam splitter and provide a mirror output having the second polarization.

2. The apparatus of claim 1, further comprising:
A second polarizing beam splitter to receive the half-wave plate output and the mirror output and transmit the half-wave plate output and the mirror output to an external reflective component, the second polarizing beam splitter further to receive reflected light from the reflective component and to transmit the light from the reflective component as an external output beam.

3. The apparatus of claim 2, wherein:
The reflective component is an image modulation component.

4. A system comprising:
A housing;
A first light source coupled to the housing, the first light source providing red light;
A second light source coupled to the housing, the second light source providing green light;
A third light source coupled to the housing, the third light source providing blue light;
A first beam combining optical element and a second beam combining optical element both coupled to the housing, the first beam combining optical element arranged to receive light from the first light source and the second light source, the second beam combining optical element arranged to receive light from the first beam combining optical element and from the third light source;
An LCoS assembly coupled to the housing and arranged to receive light from the second beam recombining element, the LCoS assembly including:
A polarization beam splitter arranged to receive light from the second beam combining element, the polarization beam splitter including:
A first polarizing beam splitter to receive light from the second beam combining element and provide a first output with a first polarization and a second output with a second polarization;
A half-wave plate arranged to receive the first output of the first polarizing beam splitter and provide a half-wave plate output having the second polarization;
A mirror arranged to receive the second output beam of the first polarizing beam splitter and provide a mirror output having the second polarization;
And
A second polarizing beam splitter to receive the half-wave plate output and the mirror output and transmit the half-wave plate output and the mirror output to an external reflective component, the second polarizing beam splitter further to receive reflected light from the reflective component and to transmit the light from the reflective component as an external output beam;
A first LCoS chip coupled to receive light from the polarization beam splitter and to reflect modulated light to the polarization beam splitter;
And
A second LCoS chip coupled to receive light from the polarization beam splitter and to reflect modulated light to the polarization beam splitter.

5. The system of claim 4, further comprising:
A first focusing optical element interposed between the first light source and the first beam recombining optical element to focus light from the first light source on the first beam recombining element;
A second focusing optical element interposed between the second light source and the first beam recombining optical element to focus light from the second light source on the first beam recombining element;
A third focusing optical element interposed between the third light source and the second beam recombining optical element to focus light from the third light source on the second beam recombining element;
And
Output focusing optics coupled to the housing and arranged to focus an output beam of the polarization beam splitter of the LCoS array.

6. The system of claim 5, wherein:
The first beam recombining optical element is a dichroic mirror; and the second beam recombining optical element is a dichroic mirror.

7. The system of claim 5, further comprising:
A controller coupled to the first light source, the second light source and the third light source, the controller coupled to control light output of the first light source, the second light source and the third light source.

8. The system of claim 7, further comprising:
A polarization switch coupled to the controller and disposed between the second beam recombining optical element and the LCoS assembly, the polarization switch controlled by the controller.

9. The system of claim 8, further comprising:
An eyeglass interface coupled to the controller, the controller to determine signals output by the eyeglass interface.

10. The system of claim 4, wherein:
The first light source is an LED, the second light source is an LED and the third light source is an LED.

11. The system of claim 4, wherein:
The first light source is a laser diode, the second light source is a laser diode and the third light source is a laser diode.

12. The system of claim 8, wherein:
The polarization switch is a PLZT switch.

13. The system of claim 6, further comprising:
A processor;
A memory coupled to the processor;
A bus coupled to the memory and the processor;
And
A communications path between the processor and each of the first and second LCoS chips.

14. The system of claim 13, further comprising:
An interface coupled to the processor, the interface to receive data from a source external to the system.

15. The system of claim 7, further comprising:
A processor;
A memory coupled to the processor;
A bus coupled to the memory and the processor;
A communications path between the processor and each of the first and second LCoS chips;
And
Wherein the processor provides the controller.

16. The system of claim 4, further comprising:
A first dichroic mirror and a second dichroic mirror both coupled to the housing, the first dichroic mirror arranged to receive light from the first light source and the second light source, the second dichroic mirror arranged to receive light from the first dichroic mirror and from the third light source;
A first focusing optical element interposed between the first light source and the first dichroic mirror to focus light from the first light source on the first dichroic mirror;
A second focusing optical element interposed between the second light source and the first dichroic mirror to focus light from the second light source on the first beam combining element;
A third focusing optical element interposed between the third light source and the second dichroic mirror to focus light from the third light source on the second beam combining element;
Output focusing optics coupled to the housing and arranged to focus an output beam of the polarization beam splitter of the LCoS array;
A controller coupled to the first light source, the second light source and the third light source, the controller coupled to control light output of the first light source, the second light source and the third light source; the controller is to sequence the first light source, the second light source and the third light source;
A processor;
A memory coupled to the processor;
A bus coupled to the memory and the processor;
And
A communications path between the processor and each of the first and second LCoS chips and the controller.

17. A method, comprising:
Programming a light modulator with a blue image;
Illuminating a blue light source;
Programming a light modulator with a red image;
Illuminating a red light source;
Programming a light modulator with a green image;
and
Illuminating a green light source.

18. The method of claim 17, further comprising:
Programming a half-wave plate to pass light of a first polarization;
Performing the programming of the blue, red and green images and the illuminating of the blue, red and green light sources;
Programming a half-wave plate to pass light of a second polarization;
And
Performing the programming of the blue, red and green images and the illuminating of the blue, red and green light sources.

19. The system of claim 18, further comprising:
Focusing light output from the image modulator as an output beam.

20. The method of claim 19, further comprising:
Controlling sequencing of the illuminating of the red, blue and green light sources.
